(19) United States
(12) Patent Application Publication
(10) Pub. No.: US 2021/0103351 A1
(43) Pub. Date: Apr. 8, 2021

(54) DISPLAY DEVICE

(71) Applicant: SHARP KABUSHIKI KAISHA, Sakai City, Osaka (JP)

(72) Inventors: KOHICHI ASO, Sakai City, Osaka (JP); NOZOMU KOHSAKA, Sakai City, Osaka (JP)

(21) Appl. No.: 16/605,148

(22) PCT Filed: Apr. 12, 2018
(86) PCT No.: PCT/JP2018/015325

§ 371 Date: Oct. 14, 2019

(30) Foreign Application Priority Data
Apr. 19, 2017 (JP) 2017-082704

(51) Int. Cl. G06F 3/041; G06F 3/044; G02F 1/1333

(52) U.S. Cl. CPC G06F 3/0412; G06F 2203/04108; G02F 1/13338; G06F 3/0446

(57) ABSTRACT

A display device includes a display panel configured to display an image, a proximity sensor extending along an outer periphery of the display panel and configured to generate capacitance with a conductor to detect presence of the conductor near the proximity sensor, and a connector electrically connected to the proximity sensor and a component of the display device other than the proximity sensor.

### TECHNICAL FIELD

The present invention relates to a display device.

### BACKGROUND ART

A known example of a liquid crystal display device is described in Patent Document 1 below. The liquid crystal display device described in Patent Document 1 includes a liquid crystal display panel, a transparent member covering the display surface of the liquid crystal display panel, a backlight device disposed on an opposite side of the liquid crystal display panel from the display surface, a frame having an opening into which the liquid crystal display panel is fitted, and a protector disposed adjacent to a main surface of the backlight device away from the display surface. The backlight device has a grounded conductive plate on the main surface away from the display surface and a loop capacitive proximity sensor located outwardly away from the grounded conductive plate in plan view.

### RELATED ART DOCUMENT

### Patent Document

Patent Document 1: Japanese Unexamined Patent Application Publication No. 2015-138125

### Problem to be Solved by the Invention

In the liquid crystal display device in Patent Document 1, the capacitive proximity sensor is disposed on the protector collectively housing the backlight device, the frame surrounding the outer surfaces of the backlight device, and the grounded conductive plate on the main surface of the backlight device away from the display surface. This configuration needs a dedicated wiring board for detecting signals from the capacitive proximity sensor at a position near the protector, leading to an increase in the number of components and an increase in the entire size.

### DISCLOSURE OF THE PRESENT INVENTION

The present invention was made in view of the above-described circumstance. An object thereof is to achieve reduction in the number of components and downsizing.

### Means for Solving the Problem

A display device according to the present invention includes a display panel configured to display an image, a proximity sensor extending along an outer periphery of the display panel and configured to generate capacitance with a conductor to detect presence of the conductor near the proximity sensor, and a connector electrically connected to the proximity sensor and a component of the display device other than the proximity sensor.

In this configuration, the proximity sensor extending along the outer periphery of the display panel generates capacitance with the conductor, enabling detection of the approaching conductor. The existing connector electrically connected to a component of the display device other than the proximity sensor is electrically connected to the proximity sensor. This requires a smaller number of components than a configuration having a connector dedicated to the proximity sensor and does not require a space for the connector, reducing the overall size.

The following configurations are preferable as embodiments of the invention.

(1) The display device includes a position detection electrode disposed on the display panel over a display surface on which an image is displayed and configured to generate capacitance with the conductor to detect a position of input by the conductor. The proximity sensor is located so as not to overlap the position detection electrode. In this configuration, the position detection electrode, which is located on the display panel over the display surface on which an image is displayed, generates capacitance with the conductor that inputs a position in the display surface, enabling detection of the position of input by the conductor. The proximity sensor, which is located away from the position detection electrode, is unlikely to be affected by noise from the position detection electrode. This reduces the possibility that the proximity sensor will incorrectly detect the approaching conductor.

(2) The connector is a panel connector electrically connected to the display panel. In this configuration, the proximity sensor is electrically connected to the panel connector electrically connected to the display panel. The panel connector is larger than connectors connected to the components other than the display panel. This configuration allows the connector to readily have a structure for connection with the proximity sensor and facilitates the connection operation to the proximity sensor.

(3) The proximity sensor extends along the outer periphery of the display panel and has at least an overlapping portion overlapping the panel connector. The proximity sensor is electrically connected to the panel connector at the overlapping portion. In this configuration, the proximity sensor surrounds the display panel and has at least a portion overlapping the panel connector electrically connected to the display panel. The proximity sensor and the connector are readily electrically connected to each other at the overlapping portion.

(4) The connector has a proximity sensor driving member configured to drive the proximity sensor. In this configuration, the proximity sensor is driven by the proximity sensor driving member on the connector. This configuration allows the connector to be used as the installation site of the proximity sensor driving member, reducing the overall size.

(5) The proximity sensor includes two or more divided proximity sensors separated from each other in a direction along a perimeter of the display panel. In this configuration, the resistance is small compared with that of a proximity sensor having a solid structure. Thus, the divided proximity sensors detect the conductor with higher sensitivity.

(6) The display device includes a frame located on an opposite side of the display panel from the display surface and extending along the outer periphery of the display panel. The proximity sensor has at least a portion located on an end portion of the frame adjacent to the display panel. In this configuration, at least a portion of the proximity sensor is located on an end portion adjacent to the display panel of the frame, which is located on a side of the display panel away from the display surface and extending along the outer periphery of the display panel. This configuration enables the proximity sensor to detect the conductor approaching the display panel from the side of the display panel away from the frame with high sensitivity. Furthermore, the proximity sensor having at least a portion on the end portion of the frame is readily electrically connected to the connector.

(7) The display device includes a frame located on an opposite side of the display panel from the display surface and extending along the outer periphery of the display panel. The proximity sensor has at least a fixing portion mechanically fixed to the frame and the proximity sensor is formed of metal. In this configuration, the proximity sensor is mechanically fixed to the frame, which is located on a side of the display panel away from the display surface and extends along the outer periphery of the display panel, by the fixing portion. This configuration allows the proximity sensor to be stably fixed to the frame. Furthermore, the proximity sensor formed of metal is electrically connected to the connector.

(8) The display device includes a frame located on an opposite side of the display panel from the display surface and extending along the outer periphery of the display panel. The proximity sensor includes a conductive tape electrically connected to the connector and a fixing layer on a surface of the conductive tape adjacent to the frame. In this configuration, the conductive tape electrically connected to the connector is fixed to the frame by the fixing layer on the surface of the conductive tape adjacent to the frame located on the side of the display panel away from the display surface and extends along the outer periphery of the display panel. This allows the proximity sensor to be reliably fixed to the frame.

(9) The display device includes a frame located on an opposite side of the display panel from the display surface and extending along the outer periphery of the display panel. The frame is formed of a synthetic resin material. The proximity sensor is formed of a conductive resin material and is integrated with the frame. A double molding technique, for example, may be employed to integrally form the proximity sensor, which is formed of a conductive resin material, and the frame, which is formed of a synthetic resin and extends along the outer periphery of the display panel on the side of the display panel away from the display surface. This eliminates the need for an assembling operation required in the configuration in which the proximity sensor and the frame are separate members. This configuration is preferably employed to reduce the cost.

(10) The proximity sensor includes at least a protruding connection portion protruding from the frame in a direction intersecting the direction along the perimeter and in a direction in which the connector extends from the component. The protruding connection portion is electrically connected to the connector. In this configuration, the protruding connection portion of the proximity sensor formed of a conductive resin material protrudes from the frame in the direction intersecting the direction along the perimeter and in the direction in which the connector extends from the component of the display device other than the proximity sensor. This facilitates the operation of electrically connecting the proximity sensor to the connector.

### Advantageous Effect of the Invention

In the present invention, reduction in the number of components and downsizing are achieved.

### BRIEF DESCRIPTION OF THE DRAWINGS

FIG. 1 is a plan view illustrating a liquid crystal panel and a backlight device included in a liquid crystal display device according to a first embodiment of the invention.

FIG. 2 is a plan view illustrating a touch panel and a cover glass included in the liquid crystal display device.

FIG. 3 is a plan view illustrating the touch panel.

FIG. 4 is a plan view illustrating a chassis and a proximity sensor included in the backlight device.

FIG. 5 is a cross-sectional view illustrating the liquid crystal display device.

FIG. 6 is a cross-sectional view illustrating the backlight device to which the liquid crystal panel and the proximity sensor are attached.

FIG. 7 is a cross-sectional view illustrating a liquid crystal display device according to a second embodiment of the invention.

FIG. 8 is a cross-sectional view illustrating a liquid crystal display device according to a third embodiment of the invention.

FIG. 9 is a plan view illustrating a chassis and a proximity sensor included in a backlight device according to a fourth embodiment of the invention.

FIG. 10 is a cross-sectional view illustrating a liquid crystal display device.

FIG. 11 is a plan view illustrating a chassis and a proximity sensor included in a backlight device according to a fifth embodiment of the invention.

### MODES FOR CARRYING OUT THE INVENTION

### First Embodiment

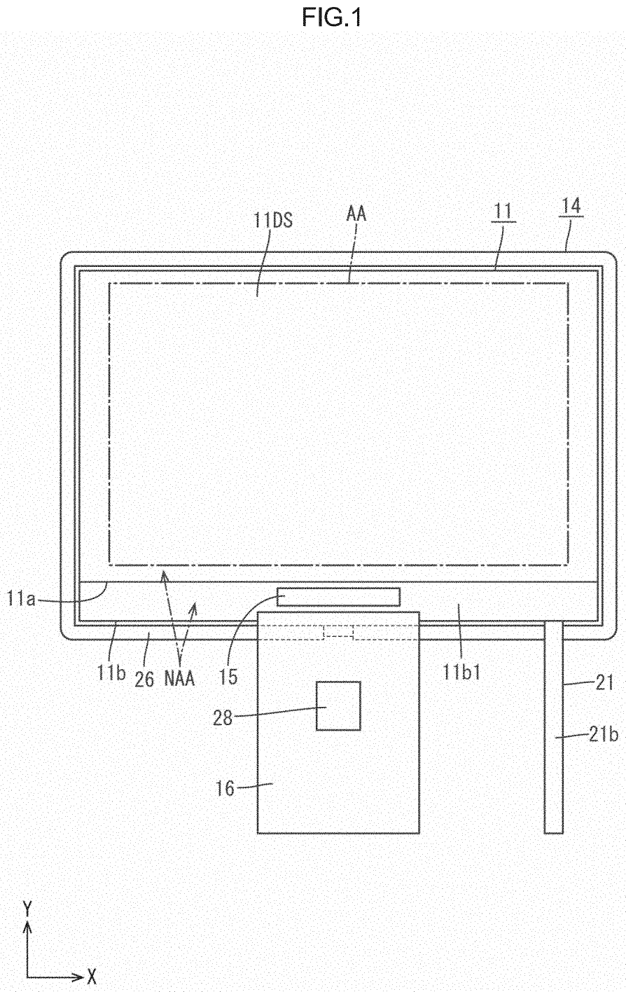

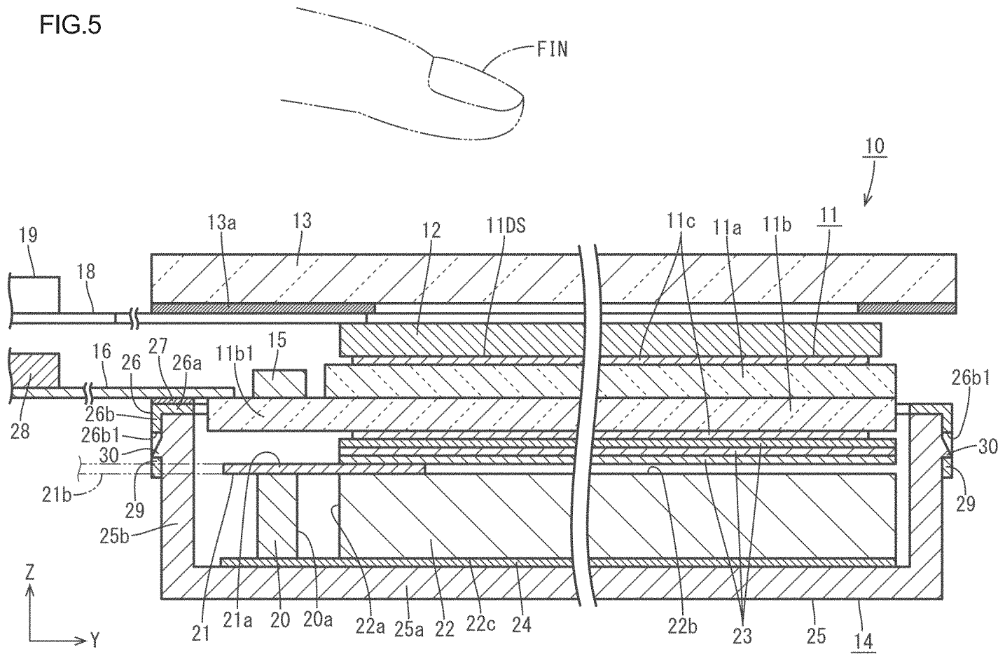

A first embodiment of the invention is described with reference to FIGS. 1 to 6. In this embodiment, a liquid crystal display device 10 is described as an example. The X axis, the Y axis, and the Z axis are indicated in some of the drawings, and each of the axes indicates the same direction in the respective drawings. Furthermore, the upper side in FIG. 5 is a front side and the lower side in FIG. 5 is a rear side.

As illustrated in FIG. 1, the liquid crystal display device 10 has a horizontally long rectangular overall shape. The long-side direction of the liquid crystal display device 10 matches the X axis direction and the short-side direction thereof matches the Y axis direction. As illustrated in FIG. 5, the liquid crystal display device 10 includes at least a liquid crystal panel (display panel) 11 having a display surface 11DS on which an image is displayed, a touch panel 12 disposed over a front surface of the liquid crystal panel 11 (surface away from the backlight device 14), a cover glass (panel protector) 13 covering the front surface of the touch panel 12, and a backlight device (lighting device) 14 disposed over a rear surface of the liquid crystal panel 11 (side away from the touch panel 12). The backlight device 14 is an external light source that applies display light to the liquid crystal panel 11. The liquid crystal display device 10 of this embodiment is preferably mounted in a car navigation system, for example, but may be mounted in other systems.

As illustrated in FIG. 5, the liquid crystal panel 11 includes two substantially transparent substrates 11a and 11b attached to each other with a predetermined space (cell gap) therebetween and liquid crystals sealed between the substrates 11a and 11b. One of the substrates 11a and 11b on the rear side is an array substrate (active matrix substrate) 11b. The array substrate 11b has switching devices (such as TFTs) connected to source lines and gate lines arranged perpendicular to each other, pixel electrodes connected to the switching devices, and a component such as an alignment film. The array substrate 11b includes a glass substrate having the above-described components thereon. One of the substrates 11a and 11b on the front side is a CF substrate (counter substrate) 11a. The CF substrate 11a has a color filter having R (red), G (green), and B (blue) coloring portions in a predetermined arrangement, a light-blocking portion (black matrix) separating the adjacent coloring portions, and components such as a counter electrode and an alignment film. The substrates 11a and 11b have front and rear polarizing plates 11c on the outer surfaces. The front surface of the polarizing plate 11c on the front surface of the CF substrate 11a constitutes the display surface 11DS.

As illustrated in FIG. 1, the display surface 11DS of the liquid crystal panel 11 has a display area (active area) AA capable of displaying an image and a frame-like shaped non-display area (non-active area) NAA surrounding the display area AA and uncapable of displaying an image. In FIG. 1, the one-dot chain line indicates the outline of the display area AA. The area outside the one-dot chain line is the non-display area NAA. The CF substrate 11a included in the liquid crystal panel 11 has short sides shorter than the short sides of the array substrate 11b. The CF substrate 11a and the array substrate 11b are attached to each other with ends at one of the ends in the short-side direction (Y axis direction) being put together. Thus, the array substrate 11b has a CF substrate non-overlapping portion 11b1, which protrudes horizontally from the CF substrate 11a and does not overlap the CF substrate 11a, at the other end in the short-side direction. The CF substrate non-overlapping portion 11b1 is the non-display area NAA. A liquid crystal panel driver (panel driving member) 15 that drives the TFTs, for example, in the display area AA is mounted on the CF substrate non-overlapping portion 11b1 by using Chip On Glass (COG) technology. A liquid crystal panel flexible board (connector, panel connector) 16 that transmits display signals to the liquid crystal panel driver 15 is connected to the CF substrate non-overlapping portion 11b1. The liquid crystal panel driver 15 and the liquid crystal panel flexible board 16 are disposed on the front side of the CF substrate non-overlapping portion 11b1 in the Z axis direction.

The liquid crystal panel driver 15 includes an LSI chip having a driving circuit therein. When driven by a signal from a control board (panel control board) (not illustrated), which is a signal source, the liquid crystal panel driver 15 processes an input signal from the control board and generates an output signal, and then outputs the output signal to the display area AA of the array substrate 11b. The liquid crystal panel flexible board 16 includes a base member formed of a synthetic resin material (for example, a polyimide resin) having insulating properties and flexibility and has multiple wiring patterns (not illustrated) on the base member. The liquid crystal panel flexible board 16 has a folded end in an area overlapping the liquid crystal display device 10 and is electrically and mechanically connected to the control board at one end in the long-side direction through an anisotropic conductive film (ACF) and to the array substrate 11b of the liquid crystal panel 11 at the other end through an ACF. The liquid crystal panel flexible board 16 has terminals (not illustrated) so as to be conductively connected to the connection targets through the ACFs.

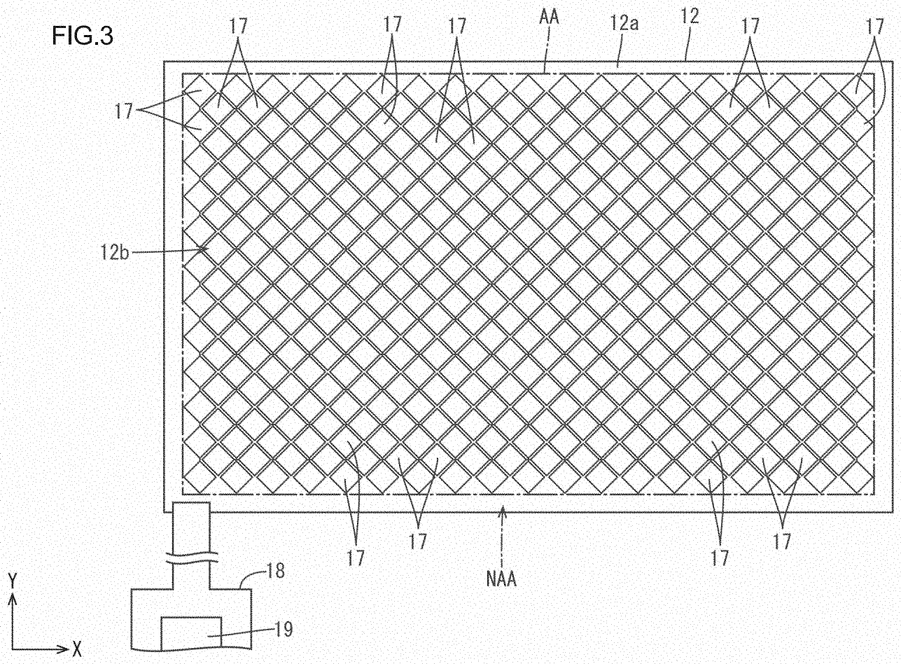

Next, the touch panel 12 is described. The touch panel 12 enables a user of the liquid crystal display device 10 to input a position based on the image on the display surface 11DS of the liquid crystal panel 11 (touching action). As illustrated in FIG. 3, the touch panel 12 is disposed over the front surface (surface away from the backlight device 14) of the liquid crystal panel 11. The touch panel 12 is a projected capacitive touch panel and employs self-capacitive detection, for example. The touch panel 12 includes a substantially transparent (high light-transmissive) glass substrate 12a and a touch panel pattern 12b obtained by patterning a substantially transparent light transmissive conductive film on the substrate 12a. The substrate 12a has a horizontally long rectangular shape in plan view. The substrate 12a has substantially the same shape and size in plan view as the liquid crystal panel 11. The touch panel pattern 12b includes at least multiple touch electrodes (position detection electrodes) 17 arranged in a matrix over the display surface 11DS of the liquid crystal panel 11. The touch electrodes 17 are disposed in an area (touch area) of the touch panel 12 that overlaps the display area AA of the liquid crystal panel 11. Thus, the display area AA of the liquid crystal panel 11 substantially matches the touch area where the input position is detectable and the non-display area NAA substantially matches a non-touch area where the input position is undetectable. When a user moves his/her finger (position input body) FIN, which is a conductor, toward the display surface 11DS to input a position based on an image in the display area AA as illustrated in FIG. 5, capacitance is generated between the finger FIN and the touch electrode 17. The capacitance detected at the touch electrode 17 near the finger FIN changes as the finger approaches, and the touch electrode 17 becomes distinguishable from the other touch electrodes 17 away from the finger FIN, enabling the detection of the input position.

As illustrated in FIG. 3, a touch panel flexible board (connector, position detection connector) 18 that transmits a signal from a touch panel control circuit (not illustrated), for example, is each connected to an outer peripheral portion of the substrate 12a of the touch panel 12 on the same side as the CF substrate non-overlapping portion 11b1. The touch panel flexible board 18 includes a base member formed of an insulating and flexible synthetic resin material as the liquid crystal panel flexible board 16. The base member is connected to the substrate 12a of the touch panel 12 at one end through an ACF and connected to the control board at the other end through an ACF. In this embodiment, the touch panel control circuit is included in the control board. The touch panel flexible board 18 has terminals (not illustrated) at the both end portions so as to be conductively connected to the connection targets through the ACFs. The touch panel flexible board 18 is disposed on the front side of the touch panel 12 in the Z axis direction and is located adjacent to an end of the touch panel 12 in the X axis direction such that the touch panel flexible board 18 is located away from the liquid crystal panel driver 15. The touch panel flexible board 18 is narrower and smaller than the liquid crystal panel flexible board 16 but has a widened portion where the touch panel driver (position detection electrode driving member) 19 is mounted. The touch panel driver 19 includes an LSI chip as the liquid crystal panel driver 15. When activated by a signal from the touch panel control circuit included in the control board, the touch panel driver 19 processes a detection signal from the touch electrode 17 and supplies a control signal to the touch electrode 17. Furthermore, touch wiring lines (not illustrated) are disposed in a non-touch area (area overlapping the non-display area NAA) outside the touch area while being connected to the touch electrodes 17 at one end and connected to the touch panel flexible board 18 at the other end.

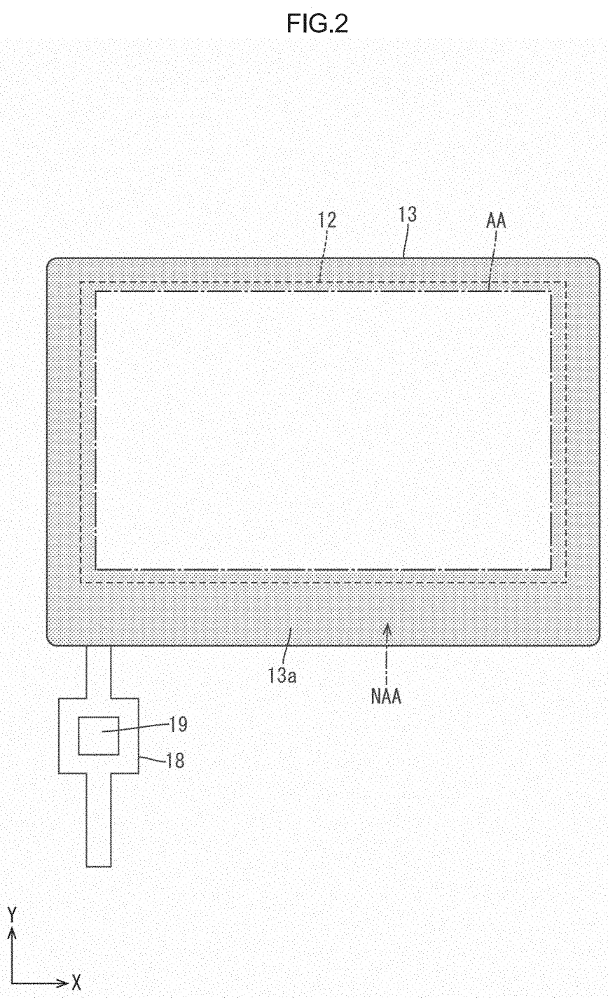

As illustrated in FIG. 2, the cover glass 13 has a horizontally long rectangular shape and covers substantially the entire front surfaces of the liquid crystal panel 11 and the touch panel 12 to protect the liquid crystal panel 11 and the touch panel 12. The cover glass 13, which is located over the front surface of the touch panel 12, is fixed to the touch panel 12 with a substantially transparent fixing tape (not illustrated). The cover glass 13 has a light-blocking portion 13a formed of a light-blocking material and extending along an entire outer periphery of the cover glass 13. The formation area of the light-blocking portion 13a substantially overlaps the non-display area NAA of the liquid crystal panel 11. The light-blocking portion 13a is shaded in FIG. 2 and indicated by a bold line in FIG. 5. The cover glass 13 has a plate-like shape and is formed of substantially transparent and high light-transmissive glass. The cover glass 13 is preferably formed of toughened glass. A preferable example of the toughened glass forming the cover glass 13 includes, but is not limited to, chemically toughened glass having a chemically toughened top layer obtained through a chemical treatment on a surface of a plate-like glass substrate.

Next, a backlight device 14 is described. As illustrated in FIG. 5, the backlight device 14 includes at least LEDs (light emitting diodes) 20, an LED board (light source board, connector, light source connector) 21 on which the LEDs 20 are mounted, a light guide plate 22 that guides the light from the LEDs 20, an optical sheet (optical member) 23 disposed on the front surface of the light guide plate 22, a reflection sheet (reflector) 24 disposed on the rear surface of the light guide plate 22, and a chassis (housing, casing) 25 housing the LEDs 20, the light guide plate 22, and the optical sheet 23, for example. The backlight device 14 is a one-side edge-lit (side-lit) backlight device in which the LEDs 20 and the LED board 21 are disposed at one end in the short-side direction (Y axis direction) such that light is applied to the light guide plate 22 through only one side. Next, the components of the backlight device 14 are described in detail.

The LED 20 illustrated in FIG. 5 includes an LED chip sealed with a sealing material on a base fixed to the LED board 21. The LED chip of the LED 20 emits a single-color light such as blue light. The sealing material contains a phosphor (such as a yellow phosphor, a green phosphor, and a red phosphor) in a dispersed state such that the LED 20 emits white light as a whole. The LED 20 is a side-emitting LED in which the surface adjacent to the surface in contact with the LED board 21 is a light emitting surface 20a. The LED board 21 is located on the front surface of the light guide plate 22 and is sandwiched between the light guide plate 22 and the optical sheet 23. The LED board 21 is a flexible film-like member (sheet) formed of an insulating material. The LED board 21 includes an LED mounting portion 21a extending in the X axis direction and having the LEDs 20 thereon and a lead-out portion 21b extending from the LED mounting portion 21a in the Y axis direction to the outside of the chassis 25. The rear surface of the LED board 21 is a mounting surface on which the LEDs 20 are disposed at an interval in the X axis direction. The mounting surface has a wiring pattern (not illustrated) through which power is supplied to the LEDs 20.

The light guide plate 22 is formed of a substantially transparent synthetic resin (an acrylic resin such as PMMA and polycarbonate, for example) and has a refractive index sufficiently higher than that of air. As illustrated in FIG. 5, the light guide plate 22 has a horizontally long plate-like shape as the liquid crystal panel 11. The light guide plate 22 is housed in the chassis 25 with the side surfaces being surrounded by the chassis 25. The light guide plate 22 is located directly below the liquid crystal panel 11 and the optical sheet 23. One long-side surface of the four side surfaces (left side surface in FIG. 5) of the light guide plate 22 is a light input surface (light source opposing end surface) 22a that faces the LEDs 20 and receives light from the LEDs 20. One of the front and rear plate surfaces of the light guide plate 22 that faces the front side (adjacent to the liquid crystal panel 11) is a light-exit surface 22b through which light is output toward the liquid crystal panel 11 and the other is alight-exit opposite surface 22c opposite the light-exit surface 22b. The light guide plate 22 having such a configuration receives light, which has been emitted from the LEDs 20 in the Y-axis direction, through the light-input surface 22a and allows the light to travel therein to the upper side in the Z axis direction such that the light exits through the light-exit surface 22b toward the optical sheet 23 (front side, light-exit side).

As illustrated in FIG. 5, the optical sheet 23 is disposed between the liquid crystal panel 11 and the light guide plate 22. The optical sheet 23 transmits the light from the light guide plate 22 toward the liquid crystal panel 11 and exerts predetermined optical effects on the transmitted light. The optical sheet 23 includes multiple optical sheets 23 (three optical sheets in this embodiment). Examples of the optical sheets include a diffusing sheet, a lens sheet (prism sheet), and a reflective polarizing sheet. Any two or more of the examples may be suitably selected.

As illustrated in FIG. 5, the reflection sheet 24 covers the light-exit opposite surface 22c of the light guide plate 22. The reflection sheet 24 has high reflectance and efficiently reflects the light that has leaked out through the light-exit opposite surface 22c of the light guide plate 22 toward the front side (light-exit surface 22b). The reflection sheet 24 has an outer shape slightly larger than that of the light guide plate 22 and is positioned such that one of the long-side end portions extending in the long-side direction protrudes from the light-input surface 22a toward the LEDs 20.

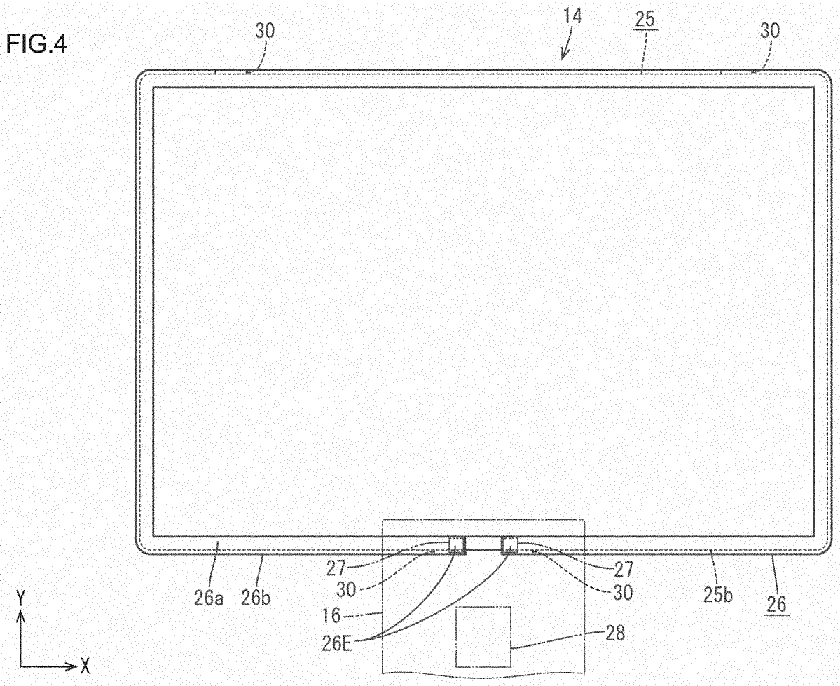

The chassis 25 is formed of a synthetic resin (such as polycarbonate). As illustrated in FIGS. 4 and 5, the chassis 25 houses the liquid crystal panel 11 in addition to the components of the backlight device 14 other than the chassis 25 (including the LEDs 20, the LED board 21, the light guide plate 22, the optical sheet 23, and the reflection sheet 24). The chassis 25 includes a bottom 25a having a horizontally long rectangular shape in a plan view slightly larger than that of the light guide plate 22 and a frame 25b extending upward in the Z axis direction (direction normal to the display surface 11DS) from the outer edges of the bottom 25a. The bottom 25a has a plate-like shape and has plate surfaces parallel to the plate surfaces (display surface 11DS) of the light guide plate 22 and the reflection sheet 24. The frame 25b has a horizontally long rectangular frame-like shape (closed ring-like shape) and has two long-side portions and two short-side portions connected at the ends. The frame 25b has a front-end portion at the same height as the array substrate 11b of the liquid crystal panel 11 and surrounds the side surfaces of the array substrate 11b over the entire perimeter. In other words, the inner surface of the front-end portion of the frame 25b faces the outer side surface of the array substrate 11b with a space therebetween. The front surface of the front-end portion of the frame 25b faces the rear surface of the liquid crystal panel flexible board 16, which is connected to the CF substrate non-overlapping portion 11b1 of the array substrate 11b, with a space therebetween.

As illustrated in FIGS. 4 and 5, the backlight device 14 includes a proximity sensor 26 that detects a finger FIN approaching the backlight device 14. The liquid crystal display device 10 is switched from the OFF state to the ON state in synchronization with the detection of the approaching finger FIN by the proximity sensor 26. Employment of such a function in a car navigation system described in this embodiment provides the user with high operability. The proximity sensor 26 is formed of metal and has a horizontally long rectangular frame-like shape in plan view. The proximity sensor 26 extends along the outer periphery of the liquid crystal panel 11 and generates capacitance with the finger FIN to enable detection of the presence of the approaching finger FIN. The proximity sensor 26 is electrically connected to the liquid crystal panel flexible board 16. The liquid crystal panel flexible board 16 is electrically connected to both the proximity sensor 26 and the liquid crystal panel 11, which is a component of the liquid crystal display device 10 other than the proximity sensor 26. In this way, the existing liquid crystal panel flexible board 16 electrically connected to the liquid crystal panel 11 is electrically connected to the proximity sensor 26. This configuration requires a smaller number of components than a configuration including a wiring board dedicated to the proximity sensor and does not require a space for the wiring board, reducing the overall size of the liquid crystal display device 10. The liquid crystal panel flexible board 16 connected to the proximity sensor 26 is generally larger than both of the touch panel flexible board 18 connected to the touch panel 12 and the lead-out portion 21b of the LED board 21 connected to the LEDs 20, which are components other than the liquid crystal panel 11. This configuration enables the liquid crystal panel flexible board 16 to readily have a connection structure to be connected to the proximity sensor 26 and facilitates the operation of connecting the liquid crystal panel flexible board 16 to the proximity sensor 26.

As illustrated in FIGS. 4 and 5, the proximity sensor 26 extends along the frame 25b of the chassis 25 and is attached to the frame 25b. In other words, the proximity sensor 26 extends along the entire outer periphery of the liquid crystal panel 11 as the frame 25b does. Thus, the proximity sensor 26 is located outwardly from the touch panel 12, which is located on the front surface of the liquid crystal panel 11, and does not overlap the touch panel 12 in plan view. Thus, the proximity sensor 26 does not overlap the touch panel pattern 12b or the touch electrodes 17 constituting the touch panel pattern 12b, which are located in the display surface 11DS of the touch panel 12. Here, the proximity sensor 26 and the touch electrodes 17 generate electrical fields when energized and the generated electrical fields may become noise for both the proximity sensor 26 and the touch electrodes 17. However, the proximity sensor 26 and the touch electrodes 17 in this embodiment do not overlap each other in plan view. In this configuration, the electrical field generated by the touch electrode 17 is unlikely to become noise for the proximity sensor 26 and the electrical field generated by the proximity sensor 26 is unlikely to become noise for the touch electrodes 17. This reduces the possibility that the proximity sensor 26 will incorrectly detect the approaching finger FIN and also reduces the possibility that the touch electrodes 17 will incorrectly detect the position of input by the finger FIN.

As described above, the proximity sensor 26 extending along the outer periphery of the liquid crystal panel 11 partly overlaps the liquid crystal panel flexible board 16 as illustrated in FIGS. 4 and 5. The overlapping portion is electrically connected to the liquid crystal panel flexible board 16. Specifically described, the proximity sensor 26 has two long-side portions and two short-side portions connected at the ends as the frame 25b. One of the long-side portions (adjacent to the CF substrate non-overlapping portion 11b1) is divided in two at the middle in the long-side direction (X axis direction). The shape of the proximity sensor 26 is different from that of the frame 25b on this point. In other words, the proximity sensor 26 has a non-closed ring-like shape and has two end portions 26E. The two end portions 26E overlap the liquid crystal panel flexible board 16 in plan view and are electrically connected to the liquid crystal panel flexible board 16. The liquid crystal panel flexible board 16 has two proximity sensor terminals 27 at the positions overlapping the proximity sensor 26. The proximity sensor terminals 27 are conductively connected to the two end portions 26E of the proximity sensor 26 located at the end of the perimeter. The proximity sensor terminal 27 and the proximity sensor 26 may be connected to each other by using solder, a conductive adhesive, or an ACF, for example. The liquid crystal panel flexible board 16 has a proximity sensor driver (proximity sensor driving member) 28 for driving the proximity sensor 26. The proximity sensor driver 28 includes an LSI chip as the liquid crystal panel driver 15. When driven by a signal from a proximity sensor control circuit in the control board, the proximity sensor driver 28 processes a detection signal from the proximity sensor 26 and supplies a control signal to the proximity sensor 26. The proximity sensor driver 28 is mounted on the front surface of the liquid crystal panel flexible board 16. This configuration, which uses the liquid crystal panel flexible board 16 as an installation site of the proximity sensor driver 28, is preferably employed to reduce the overall size.

As illustrated in FIGS. 4 and 5, the proximity sensor 26 has at least a portion located on the front-end portion of the frame 25b, i.e., the end portion on the front side (adjacent to the liquid crystal panel 11). This configuration enables the proximity sensor 26 to detect the user's finger FIN approaching the liquid crystal panel 11 from the front side (side away from the backlight device 14) with high sensitivity. The proximity sensor 26 having such a configuration is sandwiched between the liquid crystal panel flexible board 16, which is a connection target, and the frame 25b. In this configuration, the proximity sensor 26 is readily connected to the liquid crystal panel flexible board 16. Specifically described, the proximity sensor 26 is obtained by pressing a metal plate and has an L-like cross-sectional shape. The proximity sensor 26 has a sensor body 26a facing the front end surface of the frame 25b and sandwiched between the liquid crystal panel flexible board 16 and the frame 25b and a side portion 26b extending from the outer edge of the sensor body 26a and facing the outer side surfaces of the frame 25b. The sensor body 26a mainly generates capacitance with the finger FIN and has the two end portions 26E conductively connected to the proximity sensor terminals 27 of the liquid crystal panel flexible board 16. The side portion 26b has openings 26b1 arranged at an interval in the direction along the perimeter. The edges of the openings 26b1 function as fixing portions 29 fixed to the frame 25b. In contrast, the outer side surface of the frame 25b has fixing nails 30 arranged at an interval in the direction along the perimeter. The fixing nails 30 are protrusions and are inserted into the openings 26b1. The fixing nails 30 caught by the fixing portions 29, which are the opening edges of the openings 26b1, enable the proximity sensor 26 to remain stably attached to the frame 25b without coming off to the front side in the Z axis direction. The openings 26b1, the fixing portions 29, and the fixing nails 30 (four openings 26b1, four fixing portions 29, and four fixing nails 30 in this embodiment) are separately disposed at intervals in the direction along the perimeter of the frame 25b or the side portion 26b. The proximity sensor 26 preferably keeps a predetermined distance (for example, 8 mm) from conductors other than the proximity sensor 26 so as not to decrease the detection sensitivity of the proximity sensor 26.

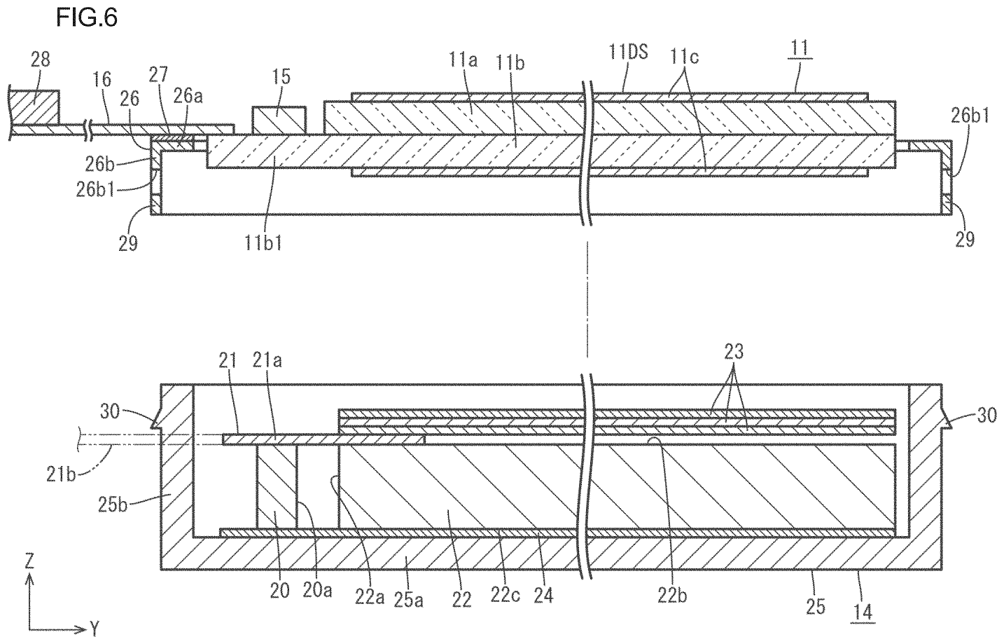

The following is a production procedure of the liquid crystal display device 10 having the above-described configuration. First, the liquid crystal panel 11, the touch panel 12, the cover glass 13, and the backlight device 14, which have each been produced by a known method, are attached to each other. In the assembling of the liquid crystal display device 10, the touch panel 12 and the cover glass 13 are fixed to each other with a fixing tape (not illustrated) and the liquid crystal panel 11 and the backlight device 14 are fixed to each other with a fixing tape. Then, the units of the components fixed to each other are fixed to each other with a fixing tape. As illustrated in FIG. 6, before the attachment of the liquid crystal panel 11 to the backlight device 14, the liquid crystal panel flexible board 16 is attached to the liquid crystal panel 11. At this time, the proximity sensor 26 included in the backlight device 14 is connected to the liquid crystal panel flexible board 16. In this operation, a mounting device for connecting the liquid crystal panel flexible board 16 to the liquid crystal panel 11 is used to connect the proximity sensor 26 to the liquid crystal panel flexible board 16. This reduces the production cost. Meanwhile, the components of the backlight device 14 except for the proximity sensor 26 are attached to each other. An assembled unit in which the liquid crystal panel flexible board 16 is connected to the liquid crystal panel 11 and the proximity sensor 26 is connected to the liquid crystal panel flexible board 16 is connected to the backlight device 14 not having the proximity sensor 26. At this time, the proximity sensor 26 is attached to the front-end portion of the frame 25b of the chassis 25 from the front side. This allows the fixing nails 30 to be inserted into the openings 26b1 in the side portion 26b and caught by the fixing portions 29. Thus, the proximity sensor 26 is fixed to the frame 25b (FIG. 5). In this way, the liquid crystal panel 11 and the backlight device 14 are attached to each other.

As described above, the liquid crystal display device (display device) 10 of this embodiment includes the liquid crystal panel (display panel) 11 configured to display an image, the proximity sensor 26 extending along the outer periphery of the liquid crystal panel 11 and configured to generate capacitance with the finger (conductor) FIN to detect the presence of the finger FIN near the proximity sensor, and the liquid crystal panel flexible board 16 electrically connected to both the proximity sensor 26 and the liquid crystal panel 11, which a component of the liquid crystal display device 10 other than the proximity sensor 26.

In this configuration, the proximity sensor 26 extending along the outer periphery of the liquid crystal panel 11 generates capacitance with the finger FIN, enabling detection of the approaching finger FIN. The existing liquid crystal panel flexible board 16 electrically connected to the liquid crystal panel 11, which is a component of the liquid crystal display device 10 other than the proximity sensor 26, is electrically connected to the proximity sensor 26. This requires a smaller number of components than a configuration having a connector dedicated to the proximity sensor and does not require a space for the connector, reducing the overall size.

The liquid crystal display device 10 further includes the touch electrode (position detection electrode) 17 disposed on the liquid crystal panel 11 over the display surface 11DS on which an image is displayed and configured to generate capacitance with the finger FIN to detect the position of input by the finger FIN. The proximity sensor 26 is located away from the touch electrode 17. In this configuration, the touch electrode 17, which is located on the liquid crystal panel 11 over the display surface 11DS on which an image is displayed, generates capacitance with the finger FIN that inputs a position in the display surface 11DS, enabling detection of the position of input by the finger FIN. The proximity sensor 26, which is located away from the touch electrode 17, is unlikely to be affected by noise from the touch electrode 17. This reduces the possibility that the proximity sensor 26 will incorrectly detect the approaching finger FIN.

Furthermore, the connector is the liquid crystal panel flexible board (panel connector) 16 electrically connected to the liquid crystal panel 11. In this configuration, the proximity sensor 26 is electrically connected to the liquid crystal panel flexible board 16 electrically connected to the liquid crystal panel 11. The liquid crystal panel flexible board 16 is larger than the lead-out portion 21b of the LED board 21 and the touch panel flexible board 18, which are connectors connected to the components other than the liquid crystal panel 11. This configuration allows the liquid crystal panel flexible board 16 to readily have a structure for connection with the proximity sensor 26 and facilitates the connection operation to the proximity sensor 26.

Furthermore, the proximity sensor 26 extends along the outer periphery of the liquid crystal panel 11 and has at least a portion overlapping the liquid crystal panel flexible board 16. The proximity sensor 26 is electrically connected to the liquid crystal panel flexible board 16 at the overlapping portion. In this configuration, the proximity sensor 26 surrounds the liquid crystal panel 11 and has at least a portion overlapping the liquid crystal panel flexible board 16 electrically connected to the liquid crystal panel 11. The proximity sensor 26 and the liquid crystal panel flexible board 16 are readily electrically connected to each other at the overlapping portion.

Furthermore, the liquid crystal panel flexible board 16 has the proximity sensor driver (proximity sensor driving member) 28 that drives the proximity sensor 26. In this configuration, the proximity sensor 26 is driven by the proximity sensor driver 28 on the liquid crystal panel flexible board 16. This configuration allows the liquid crystal panel flexible board 16 to be used as the installation site of the proximity sensor driver 28, reducing the overall size.

The liquid crystal display device 10 further includes the frame 25b located on a side of the liquid crystal panel 11 away from the display surface 11DS and extending along the outer periphery of the liquid crystal panel 11. The proximity sensor 26 has at least a portion located on an end portion of the frame 25b adjacent to the liquid crystal panel 11. In this configuration, at least a portion of the proximity sensor 26 is located on an end portion adjacent to the liquid crystal panel 11 of the frame 25b, which is located on a side of the liquid crystal panel 11 away from the display surface 11DS and extends along the outer periphery of the liquid crystal panel 11. This configuration enables the proximity sensor 26 to detect the user's finger FIN approaching the liquid crystal panel 11 from the side of the liquid crystal panel 11 away from the frame 25b with high sensitivity. Furthermore, the proximity sensor 26 having at least a portion on the end portion of the frame 25b is readily electrically connected to the liquid crystal panel flexible board 16.

The liquid crystal display device 10 further includes the frame 25b located on a side of the liquid crystal panel 11 away from the display surface 11DS and extending along the outer periphery of the liquid crystal panel 11. The proximity sensor 26 has at least the fixing portion 29 mechanically fixed to the frame 25b and is formed of metal. In this configuration, the proximity sensor 26 is mechanically fixed to the frame 25b, which is located on a side of the liquid crystal panel 11 away from the display surface 11DS and extends along the outer periphery of the liquid crystal panel 11, by the fixing portion 29. This configuration allows the proximity sensor 26 to be stably fixed to the frame 25b. Furthermore, the proximity sensor 26 formed of metal is electrically connected to the liquid crystal panel flexible board 16.

### Second Embodiment

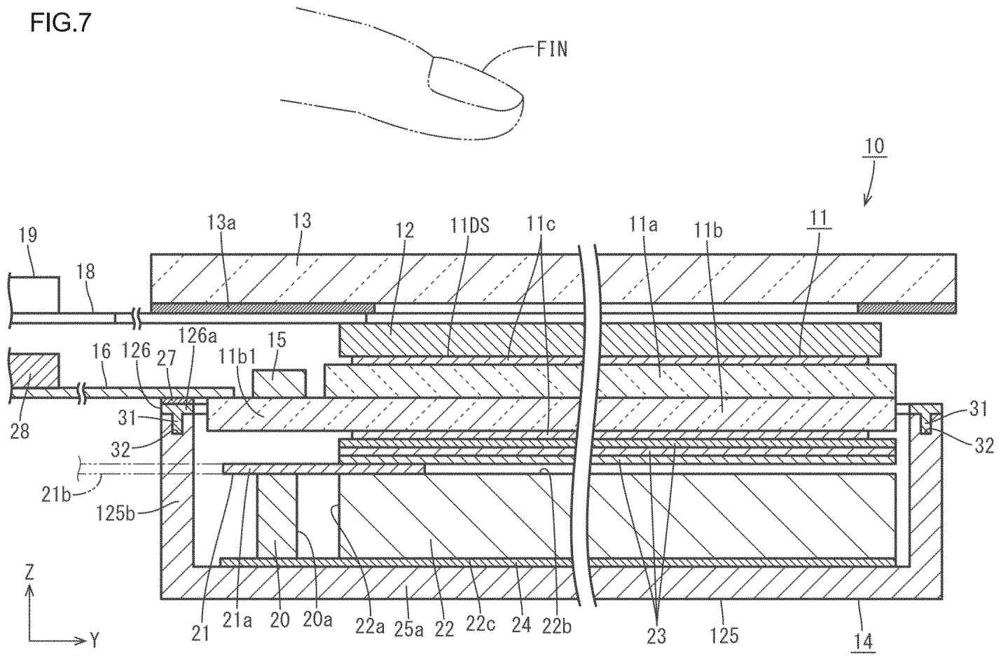

A second embodiment of the invention is described with reference to FIG. 7. In the second embodiment, a proximity sensor 126 is attached to a frame 125b in a different way. The same components, effects, and advantages as those in the first embodiment are not described.

As illustrated in FIG. 7, the proximity sensor 126 according to this embodiment includes a sensor body 126a and fixing protrusions 31 extending from a surface of the sensor body 126a that faces the frame 125b to the rear side. The frame 125b of the chassis 125 has fixing recesses 32 to be fitted with the fixing protrusions 31 in the front-end surface (surface facing the sensor body 126a). The sensor body 126a and the frame 125b, respectively, have the fixing protrusions 31 and the fixing recesses 32 at intervals in the direction along the perimeter. When the fixing protrusions 31 and the fixing recesses 32 are fitted together, the proximity sensor 126 is fixed to the frame 125b.

### Third Embodiment

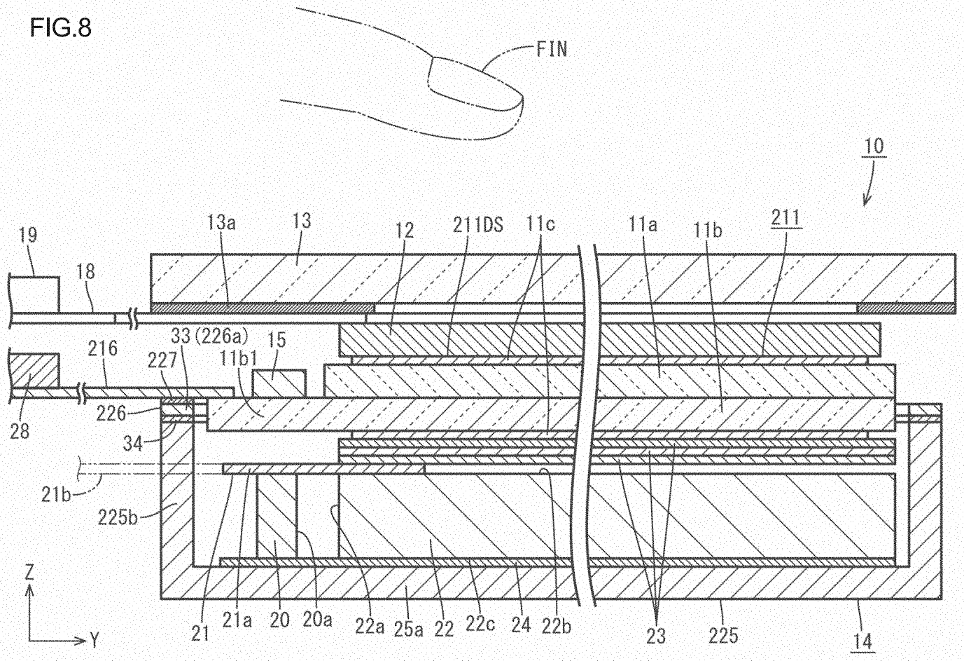

A third embodiment of the invention is described with reference to FIG. 8. In the third embodiment, a proximity sensor 226 has a different configuration from that in the first embodiment. The same components, effects, and advantages as those in the first embodiment are not described.

As illustrated in FIG. 8, the proximity sensor 226 of this embodiment includes a conductive tape 33 extending along the frame 225b of the chassis 225 and constituting a sensor body 226a and a fixing layer 34 located on a surface of the conductive tape 33 that faces the frame 225b (surface adjacent to the frame 225b). The conductive tape 33 is formed of highly conductive metal. When the conductive tape 33 is conductively connected to the proximity sensor terminal 227 of the liquid crystal panel flexible board 216, the proximity sensor 226 is electrically connected to the liquid crystal panel flexible board 216. The fixing layer 34 extends the entire length of the conductive tape 33 on the surface of the conductive tape 33 facing the frame 225b. The fixing layer 34 is formed of an adhesive material and fixes the conductive tape 33 to the frame 225b. This allows the proximity sensor 226 to be reliably fixed to the frame 225b.

As described above, this embodiment includes the frame 225b located on the side of the liquid crystal panel 211 away from the display surface 211DS and extending along the outer periphery of the liquid crystal panel 211. The proximity sensor 226 includes the conductive tape 33 electrically connected to the liquid crystal panel flexible board 216 and the fixing layer 34 on the surface of the conductive tape 33 adjacent to the frame 225b. In this configuration, the conductive tape 33 electrically connected to the liquid crystal panel flexible board 216 is fixed to the frame 225b by the fixing layer 34 on the surface of the conductive tape 33 adjacent to the frame 225b located on the side of the liquid crystal panel 211 away from the display surface 211DS and extends along the outer periphery of the liquid crystal panel 211. This allows the proximity sensor 226 to be reliably fixed to the frame 225b.

### Fourth Embodiment

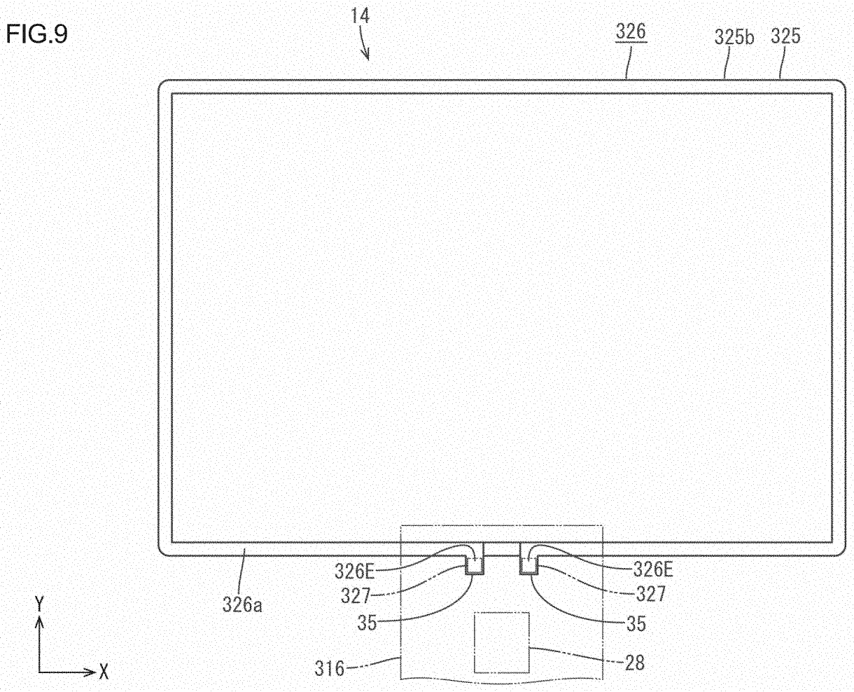

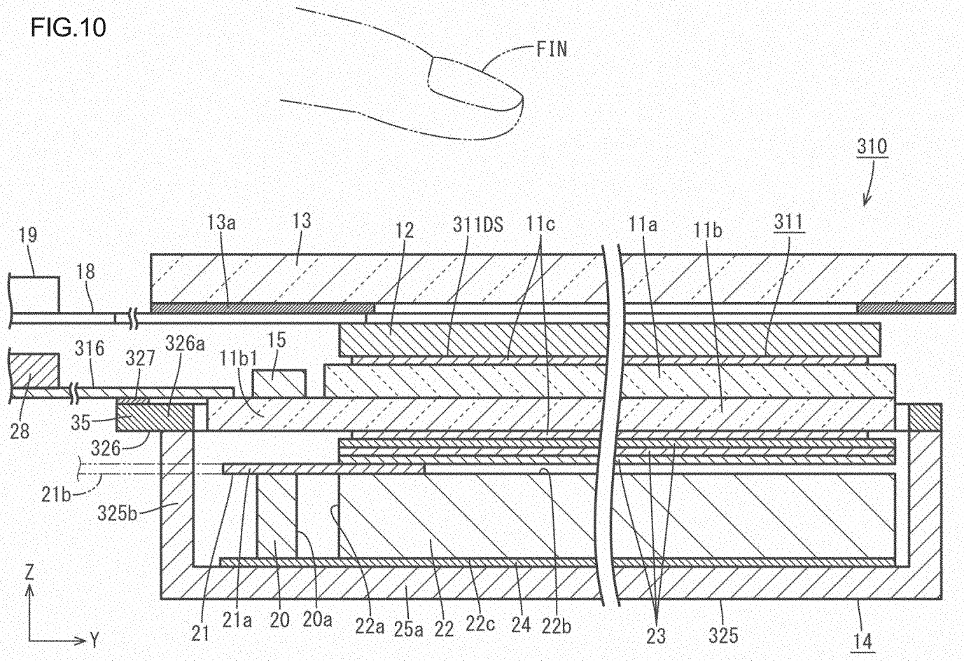

A fourth embodiment of the invention is described with reference to FIG. 9 or 10. In the fourth embodiment, a proximity sensor 326 has a different configuration from that in the first embodiment. The same components, effects, and advantages as those in the first embodiment are not described.

As illustrated in FIGS. 9 and 10, the proximity sensor 326 of this embodiment is formed of a conductive resin material and is integrated with a frame 325b of a chassis 325. The conductive resin material of the proximity sensor 326 contains a conductive material (such as carbon black and carbon fibers) in an insulating resin material and has a predetermined electrical conductivity. In this embodiment, a double molding technique is employed to produce the proximity sensor 326. The proximity sensor 326 formed of a conductive resin material and the frame 325b of the chassis 325 formed of a synthetic resin material are integrally formed by a double molding technique. This configuration eliminates the need for an assembling operation required in the first to third embodiments, which have the proximity sensor as a separate member from the frame, reducing the cost.

As illustrated in FIGS. 9 and 10, the proximity sensor 326 includes a sensor body 326a extending along the frame 325b and protruding connection portions 35 protruding outward from the sensor body 326a (frame 325b) in the Y axis direction (direction intersecting the direction along the perimeter). The protruding connection portions 35 constitute the two end portions 326E of the proximity sensor 326 located at the ends in the direction along the perimeter and are conductively connected to the proximity sensor terminals 327 of the liquid crystal panel flexible board 316. The protruding connection portion 35 protrudes from the frame 325b in the direction in which the liquid crystal panel flexible board 316 extends from the liquid crystal panel 311 and overlaps the proximity sensor terminals 327 of the liquid crystal panel flexible board 316 in plan view. As described above, the protruding connection portion 35, which protrudes outwardly from the frame 325b in the Y axis direction, and the proximity sensor terminals 327, which are connection targets of the protruding connection portions 35, do not overlap the frame 325b. This facilitates the operation of electrically connecting the protruding connection portions 35 to the proximity sensor terminals 327, leading to a further reduction in cost.

As described above, this embodiment includes the frame 325b located on the side of the liquid crystal panel 311 away from the display surface 311DS and extending along the outer periphery of the liquid crystal panel 311. The frame 325b is formed of a synthetic resin. The proximity sensor 326 is formed of a conductive resin material and integrated with the frame 325b. A double molding technique, for example, may be employed to integrally form the proximity sensor 326, which is formed of a conductive resin material, and the frame 325b, which extends along the outer periphery of the liquid crystal panel 311 on the side of the liquid crystal panel 311 away from the display surface 311DS and is formed of a synthetic resin. This eliminates the need for an assembling operation required in the configuration having the proximity sensor and the frame 325b as separate members, reducing the cost.

Furthermore, the proximity sensor 326 includes at least the protruding connection portion 35 protruding from the frame 325b in the direction intersecting the direction along the perimeter and in the direction in which the liquid crystal panel flexible board 316 extends from the liquid crystal panel 311 (component). The protruding connection portion 35 is electrically connected to the liquid crystal panel flexible board 316. In this configuration, the protruding connection portion 35 of the proximity sensor 326 formed of a conductive resin material protrudes from the frame 325b in the direction intersecting the direction along the perimeter and in the direction in which the liquid crystal panel flexible board 316 extends from the liquid crystal panel 311, which is a component of the liquid crystal display panel 310 other than the proximity sensor 326. This facilitates the operation of electrically connecting the proximity sensor 326 to the liquid crystal panel flexible board 316.

### Fifth Embodiment

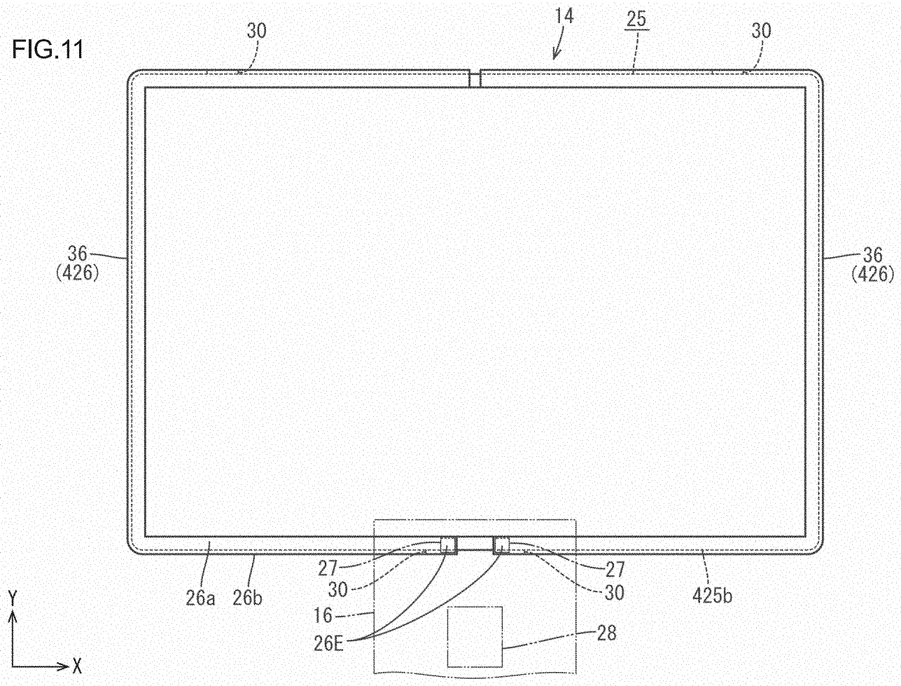

A fifth embodiment of the invention is described with reference to FIG. 11. In the fifth embodiment, a proximity sensor 426 has a different configuration from that in the first embodiment. The same components, effects, and advantages as those in the first embodiment are not described.

As illustrated in FIG. 11, the proximity sensor 426 of this embodiment includes two (multiple) divided proximity sensors 36 separated from each other in the direction along the perimeter of the frame 425b (liquid crystal panel). The two long-side portions of the proximity sensor 426 are each divided into two at the middle such that the proximity sensor 426 has a divided structure. The divided proximity sensors 36 each include one short-side portion extending along the short side of the proximity sensor 426 and two divided long-side portions extending from the ends of the short-side portion. In this configuration, the electrical resistance is reduced by about half, because the length of the divided proximity sensors 36 is reduced by about half compared with the configurations in the first to fourth embodiments in which the proximity sensors have a non-divided structure. Thus, the divided proximity sensors 36 detect the user's finger with higher sensitivity.

As described above, in this embodiment, the proximity sensor 426 includes the multiple divided proximity sensors 36 separated from each other in the direction along the perimeter of the liquid crystal panel. In this configuration, the resistance of each of the divided proximity sensors 36 is small compared with that of a proximity sensor having a solid structure. Thus, the divided proximity sensors 36 detect the user's finger with higher sensitivity.

### Other Embodiments

The present invention is not limited to the embodiments described above and illustrated by the drawings. For example, the following embodiments will be included in the technical scope of the present invention.

(1) In the above-described embodiments, the proximity sensor is electrically connected to the liquid crystal panel flexible board. However, the proximity sensor may be electrically connected to the lead-out portion of the LED board connected to the LEDs, instead of the liquid crystal panel flexible board. Alternatively, the proximity sensor may be electrically connected to the touch panel flexible board connected to the touch panel. When any one of these configurations is employed, the lead-out portion of the LED board or the touch panel flexible board needs to have the proximity sensor terminal. The proximity sensor extending along the frame is conductively connected to the proximity sensor terminal at a portion overlapping the proximity sensor terminal of the lead-out portion of the LED board or the proximity sensor terminal of the touch panel flexible board, which are connection targets. Furthermore, the proximity sensor driver is preferably disposed on the lead-out portion of the LED board or the touch panel flexible board.

(2) In the above-described embodiments, the proximity sensor is connected to the liquid crystal panel flexible board before the liquid crystal panel flexible board is connected to the liquid crystal panel. However, the procedure may be suitably changed. For example, the operation of attaching the proximity sensor to the chassis may be performed concurrently with the operation of attaching the liquid crystal panel flexible board to the liquid crystal panel, and then the liquid crystal panel flexible board and the proximity sensor may be electrically connected to each other when the liquid crystal panel and the liquid crystal panel flexible board are attached to the backlight device and the proximity sensor.

(3) The position of the liquid crystal panel flexible board in the X axis direction with respect to the liquid crystal panel and the dimension thereof may be suitably changed from those in the above-described configurations. When the position and the dimension of the liquid crystal panel flexible board are changed, the positions of the two end portions of the proximity sensor connected to the proximity sensor terminals need to be changed accordingly to overlap the liquid crystal panel flexible board. The positions of the end portions are readily changed because the proximity sensor extends along the frame.

(4) In the first and second embodiments, the metal proximity sensor, which is a separate member from the chassis formed of a synthetic resin, is attached to the frame. However, the metal proximity sensor may be integrally formed with the frame of the chassis formed of a synthetic resin by insert molding.

(5) In a modification of the third embodiment, a conductive adhesive may be applied to a surface of the conductive tape that faces the liquid crystal panel flexible board such that the liquid crystal panel flexible board is electrically connected to the proximity sensor terminals through the conductive adhesive.

(6) In the fourth embodiment, the proximity sensor integrally formed with the chassis by a double molding technique has the protruding connection portion. However, the protruding connection portion may be eliminated.

(7) In the fifth embodiment, the proximity sensor is divided into two. However, the proximity sensor may be divided into three or more.

(8) In the above-described embodiments, the touch panel pattern is the self-capacitive touch panel pattern. However, the present invention is applicable to a mutual capacitance touch panel pattern. Furthermore, the planar shape of the touch electrodes constituting the touch panel pattern is not limited to a rhombus and may be a rectangle, a circle, or a polygon having five or more sides.

(9) In the above-described embodiment, the touch panel is a separate member from the liquid crystal panel, i.e., an out-cell touch panel. However, a touch panel pattern may be integrated into the liquid crystal panel, i.e., an in-cell touch panel. Examples of the in-cell touch panels include at least a semi in-cell touch panel in which an outer surface of the CF substrate has a touch panel pattern and a full in-cell touch panel in which an inner surface of the CF substrate or the array substrate has a touch panel pattern.

(10) In the above-described embodiments, the liquid crystal display device includes a touch panel. However, the touch panel may be eliminated.

(11) In the above-described embodiments, the chassis includes the bottom and the frame. However, the bottom may be eliminated. The chassis may include only the frame.

(12) In the above-described embodiments, the LEDs are the side-emitting LEDs. However, top-emitting LEDs may be used as light sources. Furthermore, light sources other than the LEDs (such as an organic EL) may be employed.

(13) In the above-described embodiments, the backlight device is a one-side-lit backlight device that receives light through only one of the long-side side surfaces of the light guide plate. However, the backlight device may be a one-side-lit backlight device that receives light through only one of the short-side side surfaces of the light guide plate. Alternatively, the backlight device may be a two-side-lit backlight device that receives light through two long-side side surfaces or two short-side side surfaces of the light guide plate. Alternatively, the backlight device may be a three-side-lit backlight device that receives light through any three of the side surfaces of the light guide plate or a four-side-lit backlight device that receives light through all the four side surfaces of the light guide plate.

(14) In the above-described embodiments, the backlight devices are edge-lit backlight devices. However, the present invention may be applied to a direct-lit backlight device. In such a case, the direct-lit backlight device does not include a light guide plate, which is included in an edge-lit backlight device. The LED board is positioned such that the LED mounting surface faces the plate surface of the optical sheet with a distance therebetween.

(15) In the above-described embodiments, the liquid crystal display device has a horizontally long rectangular shape in a plan view. However, the shape of the liquid crystal display device in a plan view may be a vertically long rectangle, a square, an oval, an ellipse, a circle, a trapezoid, or a shape having a curved portion, for example.

(16) The application of the liquid crystal display device is not limited to that in the above-described embodiments and may be suitably changed.

(17) In the above-described embodiments, the liquid crystal display device includes a liquid crystal panel. However, the display device may include another type of display panel, such as a plasma display panel (PDP), an organic EL panel, a microcapsule electrophoretic display panel (EPD), or a micro electromechanical system (MEMS) display panel.

### EXPLANATION OF SYMBOLS

10, 310: liquid crystal display device (display device)
11, 211, 311: liquid crystal panel (display panel, component)
11DS, 211DS, 311DS: display surface
12: touch panel (component)
16, 216, 316: liquid crystal panel flexible board (connector, panel connector)
17: touch electrode (position detection electrode)
20: LED (component)
25b, 125b, 225b, 325b, 425b: frame
26, 126, 226, 326, 426: proximity sensor
28: proximity sensor driver (proximity sensor driving member)
29: fixing portion
33: conductive tape
34: fixing layer
35: protruding connection portion
36: divided proximity sensors
FIN: finger (conductor)

1. A display device comprising:
a display panel configured to display an image;
a proximity sensor extending along an outer periphery of the display panel and configured to generate capacitance with a conductor to detect presence of the conductor near the proximity sensor; and
a connector electrically connected to the proximity sensor and a component of the display device other than the proximity sensor.

2. The display device according to claim 1, further comprising a position detection electrode disposed on the display panel over a display surface on which an image is displayed and configured to generate capacitance with the conductor to detect a position of input by the conductor, wherein
the proximity sensor is located so as not to overlap the position detection electrode.

3. The display device according to claim 1, wherein the connector is a panel connector electrically connected to the display panel.

4. The display device according to claim 3, wherein the proximity sensor extends along the outer periphery of the display panel and has at least an overlapping portion overlapping the panel connector, the proximity sensor is electrically connected to the panel connector at the overlapping portion.

5. The display device according to claim 1 wherein the connector has a proximity sensor driving member configured to drive the proximity sensor.

6. The display device according to claim 1, wherein the proximity sensor includes two or more divided proximity sensors separated from each other in a direction along a perimeter of the display panel.

7. The display device according to claim 1, further comprising a frame located on an opposite side of the display panel from the display surface and extending along the outer periphery of the display panel, wherein
the proximity sensor has at least a portion located on an end portion of the frame adjacent to the display panel.

8. The display device according to claim 1, further comprising a frame located on an opposite side of the display panel from the display surface and extending along the outer periphery of the display panel, wherein
the proximity sensor includes at least a fixing portion mechanically fixed to the frame and the proximity sensor is formed of metal.

9. The display device according to claim 1, further comprising a frame located on an opposite side of the display panel from the display surface and extending along the outer periphery of the display panel, wherein
the proximity sensor includes a conductive tape electrically connected to the connector and a fixing layer on a surface of the conductive tape adjacent to the frame.

10. The display device according to claim 1, further comprising a frame located on an opposite side of the display panel from the display surface and extending along the outer periphery of the display panel, the frame being formed of a synthetic resin material, wherein
the proximity sensor is formed of a conductive resin material and is integrated with the frame.

11. The display device according to claim 10, wherein the proximity sensor includes at least a protruding connection portion protruding from the frame in a direction intersecting the direction along the perimeter and in a direction in which the connector extends from the component, and the protruding connection portion is electrically connected to the connector.
